(19) United States
(12) Patent Application Publication
(10) Pub. No.: US 2024/0372401 A1
(43) Pub. Date: Nov. 7, 2024

(54) WIRELESS CHARGING BEAMFORMING WITH IOT DEVICE PRIORITIZATION ANALYSIS

(71) Applicant: International Business Machines Corporation, Armonk, NY (US)

(72) Inventors: Su Liu, Austin, TX (US); NEIL DELIMA, Scarborough (CA); Hamid Majdabadi, OTTAWA (CA)

(21) Appl. No.: 18/309,853

(22) Filed: May 1, 2023

(51) Int. Cl. H02J 50/10; H02J 50/80; H02J 50/90

(52) U.S. Cl. CPC H02J 50/10; H02J 50/80; H02J 50/90

(57) ABSTRACT

According to one embodiment, a method, computer system, and computer program product for autonomous wireless device charge management is provided. The embodiment may include detecting a plurality of devices within a predefined space. The embodiment may also include assigning a priority to each detected device based on the battery charge level, a wireless charging capability, a class or type, and one or more characteristics of each detected device. The embodiment may further include generating a floor plan of the predefined space. The embodiment may also include assigning a priority to each detected device based on the battery charge level and the wireless charging capability of each detected device. The embodiment may further include generating a charging beamform pattern in the preconfigured space based on the assigned priority and the generated floor plan.

### BACKGROUND

The present invention relates generally to the field of computing, and more particularly to wireless charging.

All electronic devices require a power source in order to maintain an active, powered-on status. Wired devices receive power directly from an electrical source, such as a wall electrical outlet or a plug-in battery. Wireless devices receive power from embedded batteries. Many battery-powered, wireless devices allow for the recharging of those devices through a plug-in to an electrical source. However, some wireless devices also allow for wireless charging that enables recharging of an embedded battery without the need for a physical connection to a power source. Typically, wirelessly charged devices utilize electromagnetic fields to transfer energy from a charging pad or charging mat to a nearby device. For example, an electric toothbrush inductively charges its embedded battery when placed on a holder.

### SUMMARY

According to one embodiment, a method, computer system, and computer program product for autonomous wireless device charge management is provided. The embodiment may include detecting a plurality of devices within a predefined space. The embodiment may also include identifying a battery charge level, a wireless charging capability, a class or type, and one or more characteristics of each detected device. The embodiment may further include generating a floor plan of the predefined space. The embodiment may also include assigning a priority to each detected device based on the battery charge level, a wireless charging capability, a class or type, and one or more characteristics of each detected device. The embodiment may further include generating a charging beamform pattern in the preconfigured space based on the assigned priority and the generated floor plan.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment.

FIG. 2 illustrates an operational flowchart for an autonomous wireless device charge management process according to at least one embodiment.

FIG. 3 is an exemplary implementation block diagram of a system architecture for autonomous wireless device charge management according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Embodiments of the present invention relate to the field of computing, and more particularly to wireless charging. The following described exemplary embodiments provide a system, method, and program product to, among other things, manage and prioritize charging of compatible wireless devices in a predefined space through beamforming. Therefore, the present embodiment has the capacity to improve the technical field of wireless charging by identifying wireless charging compatible devices within a predefined space and prioritizing charging of those devices in relation to the capabilities of chargers within the defined space based on the current battery level and importance of the device.

As previously described, all electronic devices require a power source in order to maintain an active, powered-on status. Wired devices receive power directly from an electrical source, such as a wall electrical outlet or a plug-in battery. Wireless devices receive power from embedded batteries. Many battery-powered, wireless devices allow for the recharging of those devices through a plug-in to an electrical source. However, some wireless devices also allow for wireless charging that enables recharging of an embedded battery without the need for a physical connection to a power source. Typically, wirelessly charged devices utilize electromagnetic fields to transfer energy from a charging pad or charging mat to a nearby device. For example, an electric toothbrush inductively charges its embedded battery when placed on a holder.

With the explosive growth of devices capable of wireless charging, compatible devices have expanded from standard consumer electronics (e.g., smart phones, watches, ear bud headphones, etc.) to more industry specific devices such as, but not limited to, healthcare devices, automotives, and manufacturing devices. Many wireless charging methods rely on induction and, thus, require close contact with the charging device, such as a toothbrush on a charging stand or a cellphone on a charging mat. However, advances in wireless charging may allow devices to be powered from a distance thereby increasing portability and mobility.

Beamforming is a wireless communication technique that focuses transmission signals in a specific direction, usually towards a receiver. Although typically utilized in wireless communication environments, beamforming-based techniques for wireless power transfer are also available and focus a wireless signal towards specific receiving devices. Such beamforming technologies may be available in specific pre-defined environments, such as a hospital or an airport.

However, a wide demographic of users with different devices and various needs may require beamforming charging in a predefined space. For example, emergency services personnel may require a greater need for availability of a pager or phone when on a call or a senior or individual with a disability may require greater need for the availability of assistive devices as opposed to an individual browsing a social media application on a smartphone. As such, it may be advantageous to, among other things, provide service providers the capability to autonomously identify individuals within a predefined space and manage and operate wireless charging capabilities in a predefined space based on device type and individual device availability requirements by end users.

According to at least one embodiment, an autonomous wireless device charge management program may continuously detect and register devices within a predefined space to determine various characteristics of the device and user owner of the device. The autonomous wireless device charge management program may monitor each device's location within the predefined space through one or more location tracking techniques and each device's battery charge level. The autonomous wireless device charge management program may thereafter generate a prioritization of the wireless chargeable user devices within the predefined space according to the status of all the detected devices based on the type and/or class, battery charge level of each device and certain device owner characteristics or needs. As battery charge levels change, the autonomous wireless device charge management program may continuously update the prioritizations to account for new devices and charge levels. The autonomous wireless device charge management program may then utilize the prioritization to focus beamform charging devices toward devices to perform charging consistent with the prioritization.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

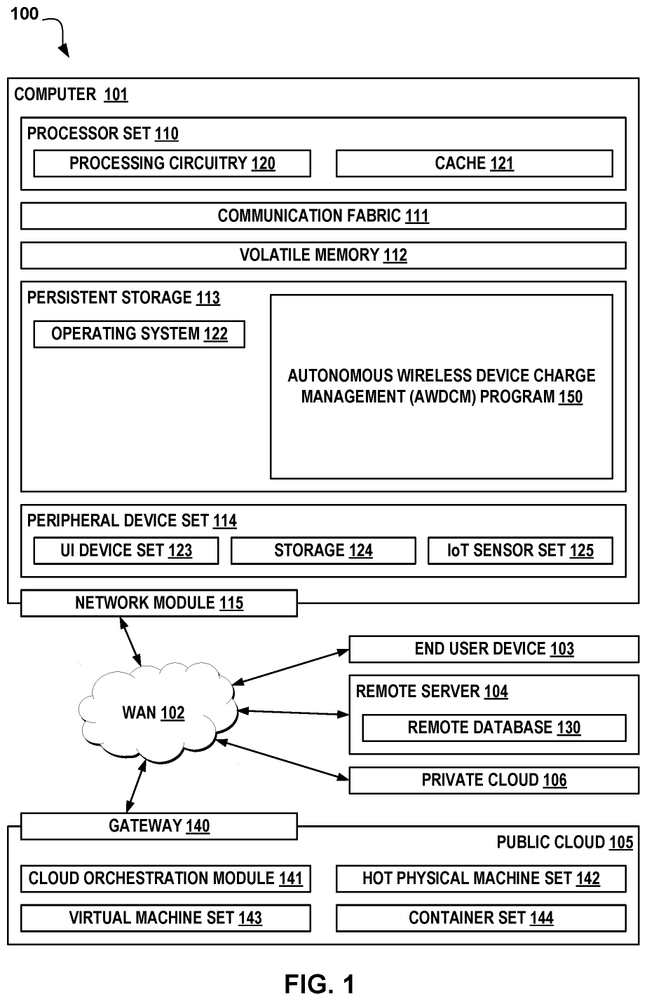

Referring now to FIG. 1, computing environment 100 contains an example of an environment for the execution of at least some of the computer code involved in performing the inventive methods, such as autonomous wireless device charge management program 150. In addition to autonomous wireless device charge management program 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and autonomous wireless device charge management program 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer, a wireless beamforming charger, or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, for illustrative brevity. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in autonomous wireless device charge management program 150 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in autonomous wireless device charge management program 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN 102 and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

According to at least one embodiment, the autonomous wireless device charge management program 150 may be capable of scanning a predefined space for wireless charging devices, registering each device to determine user and device characteristics, generating a prioritization where each device is ordered by importance and need of each device's charge level, and generating a charging pattern for one or more beamform charging devices within the predefined space based on the prioritization. The autonomous wireless device charge management program 150 may utilize or instruct various hardware units to achieve the various actions of the method including, but not limited to, a wireless charging device and wireless networking devices.

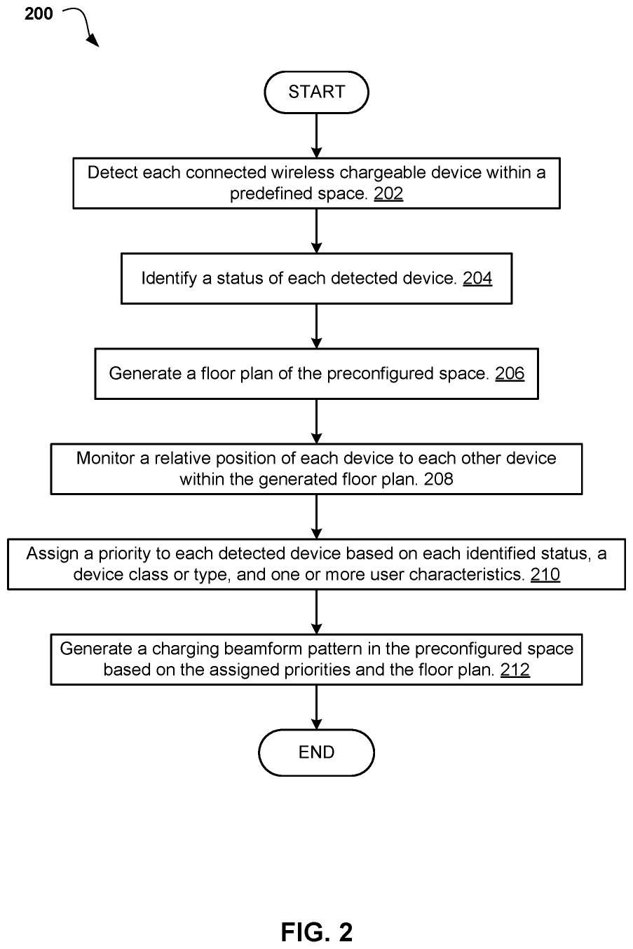

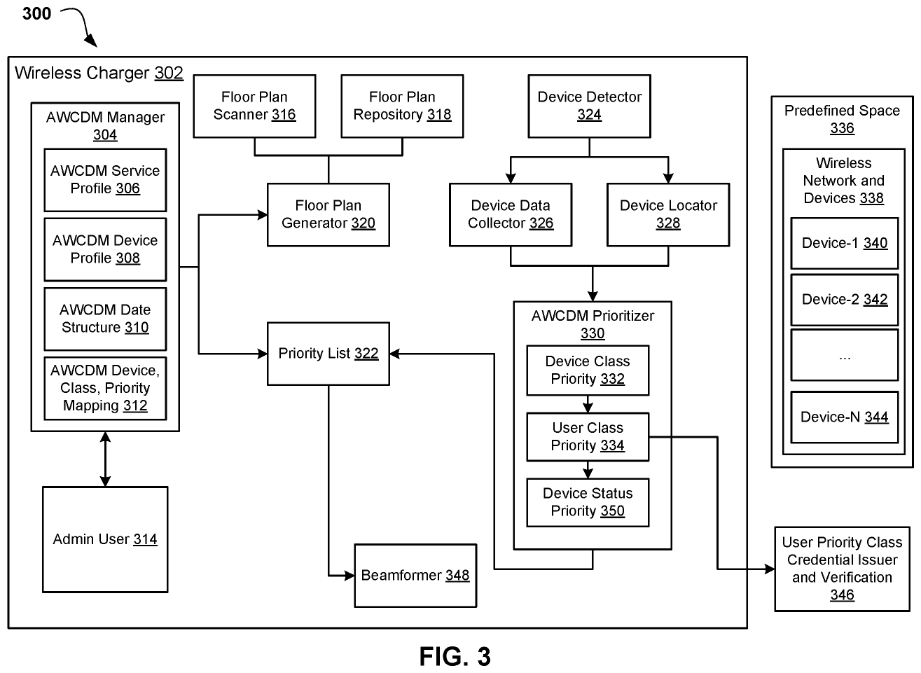

Additionally, the autonomous wireless device charge management program 150 may perform an opt-in procedure prior to establishing a connection, whether a wireless data connection or a wireless power connection, to each detected device. The opt-in procedure may include the data the autonomous wireless device charge management program 150 may capture and the purpose for which that data may be utilized by the autonomous wireless device charge management program 150 during the performance of the method. Furthermore, notwithstanding depiction in computer 101, the autonomous wireless device charge management program 150 may be stored in and/or executed by, individually or in any combination, end user device 103, remote server 104, public cloud 105, and private cloud 106. The autonomous wireless device charge management method is explained in more detail below with respect to FIGS. 2 and 3.

Referring now to FIG. 2, an operational flowchart illustrating an autonomous wireless device charge management process 200 is depicted according to at least one embodiment. At 202, the autonomous wireless device charge management program 150 detects each connected wireless chargeable device within a preconfigured space. The autonomous wireless device charge management program 150 may detect each device through a variety of methods such as, but not limited to, wireless network connections, wireless network connection attempts, image recognition, electromagnetic emissions, or any combination thereof. In one embodiment, the autonomous wireless device charge management program 150 may detect each device within the predefined space through image recognition by scanning the predefined space with image capture devices (e.g., cameras) and analyzing data captured by the image capture devices for any wireless chargeable devices depicted within the captured images. For example, a wall-mounted camera in the predefined space may capture a photograph of individuals entering the predefined space and determine that one individual is carrying a small medical refrigerator used to cool temperature sensitive samples.

In another embodiment, the autonomous wireless device charge management program 150 may utilize each device's wireless connection to detect the presence of the device within the predefined space. In such an embodiment, the predefined space may be defined by the range of the wireless connection to each router within the network. For example, the autonomous wireless device charge management program 150 may determine a device is within the predefined space when a user carrying the device enters within range of a networking route and the device automatically connects to the wireless network within the predefined space.

In yet another embodiment, the autonomous wireless device charge management program 150 may utilize connection attempts to a network wireless router to detect each device's presence within the predefined space. Similar to the previous example where a device's connection to the wireless network was used to detect each device within the predefined space, the autonomous wireless device charge management program 150 may utilize a simple attempt to connect to the wireless network within the predefined space to detect the device. Such a situation may occur when the wireless network is private, password protected or when the device attempting to connect requires user confirmation to fully connect to the network.

In a further embodiment, the autonomous wireless device charge management program 150 may utilize technologies capable of detecting electromagnetic emissions within the predefined space to detect each wireless chargeable device. Since each device being detected by the autonomous wireless device charge management program 150 operates through a power source, each device is likely to emit electromagnetic radiation which itself may be detectable to an electromagnetic detection device. If the autonomous wireless device charge management program 150 using the electromagnetic detection device detects an entity within the predefined space is emitting an electromagnetic field, the autonomous wireless device charge management program 150 may determine the identified entity is a wireless chargeable device.

Since not all devices are capable of wireless charging, the autonomous wireless device charge management program 150 may utilize any combination of the previous detection methods to identify the wireless charging status of each detected device. The autonomous wireless device charge management program 150 may also utilize a database search (e.g., an internet search) to determine various device characteristics of each detected device. For example, if the autonomous wireless device charge management program 150 detects a device through a wireless connection to the network within the predefined space, the autonomous wireless device charge management program 150 may gather metadata about the device through the connect to further identify wireless charging capabilities of the device from a database search.

In at least one embodiment, the autonomous wireless device charge management program 150 may also detect a device type or class while detecting the presence of the device within the predefined space. For example, the autonomous wireless device charge management program 150 may classify each device into a class based on a variety of device uses or purposes such as, but not limited to, medical devices, communication devices, sensor devices, personal devices, wearable devices, and entertainment devices.

Then, at 204, the autonomous wireless device charge management program 150 identifies a status of each detected device. Once each device is detected, the autonomous wireless device charge management program 150 may determine a status of each device. The status may relate to the remaining battery life as reported by the device itself or a measure of the battery charge through another measurement method, such as user reporting or a manual measurement through connection to a charge measurement device. In one embodiment, the autonomous wireless device charge management program 150 may detect the battery charge status when the device connects to a wireless network within the predefined space through a data connection established by the device and the network router and/or server. In such situations, the autonomous wireless device charge management program 150 may continually monitor the battery charge level of each detected device within the predefined space.

In one or more other embodiments, the autonomous wireless device charge management program 150 may prompt the user to manually enter the current battery charge level of the device through a graphical user interface prompt. In situations where no continually monitoring is available, the autonomous wireless device charge management program 150 may prompt the user on a preconfigured schedule to resubmit the battery charge level or request the user reconnect the device to a charge detection device to ensure the device is adequately prioritized for charging as detailed in later steps based on the current charge level.

Next, at 206, the autonomous wireless device charge management program 150 generates a floor plan of the preconfigure space. The autonomous wireless device charge management program 150 may generate a floor plan of the preconfigured space during an initialization phase. The autonomous wireless device charge management program 150 may utilize the floor plan to monitor the location of each device within the predefined space in relation to one or more wireless charging beamformers. The autonomous wireless device charge management program 150 may generate the two-dimensional or three-dimensional floor plan through one or more virtual space generation methods such as, but not limited to, digitization of an architectural floor plan document or digital mapping or virtual generation of a digital space of the predefined space through images captured by image capture devices.

Then, at 208, the autonomous wireless device charge management program 150 monitors a relative position of each device to each other device within the generated floor plan. Since users may actively navigate through the predefined space, the autonomous wireless device charge management program 150 may monitor the relative position of each device to each other device within the predefined space and understand their movement within the generated floor plan. The autonomous wireless device charge management program 150 may utilize this movement monitoring when adjusting the wireless charging beamformers during the execution of the charging prioritization discussed in more detail below.

Next, at 210, the autonomous wireless device charge management program 150 assigns a priority to each detected device based on each identified status, the device type or class, and one or more user characteristics. The autonomous wireless device charge management program 150 may assign a priority to each device based on a variety of data about the device and the user. The autonomous wireless device charge management program 150 may capture the device data and user data through various methods such as manual user input, image recognition of captured images within the predefined space, or inference based on detected device type.

In one embodiment, the autonomous wireless device charge management program 150 may capture data elements related to each device during each device's connection to a wireless network within the predefined space. Such data may include, but is not limited to, device type, battery charge level, and battery charge capabilities. For example, the autonomous wireless device charge management program 150 may determine the device is a tablet computer at 50% battery charge and compatible with wireless charging.

In another embodiment, the autonomous wireless device charge management program 150 may capture data elements related to each user within the predefined space through manual user interactions with a graphical user interface or as determined by analysis of captured images of each user within the predefined space. For example, when initially interacting with the autonomous wireless device charge management program 150 such as through the opt-in procedure, a user may indicate that a specific medical condition and/or that the user requires the assistance of an electronic medical device such as a battery-regulated oxygen tank, a glucose monitor, or a pacemaker. In another example, the autonomous wireless device charge management program 150 may determine that the user has a specific medical condition or a condition within a broader category of conditions or a condition type through image analysis and determination that the user is in possession of a specific device (e.g., wearing hearing aids) or behaving in a specific manner consistent with one or more conditions.

Based on the captured user information and device information, the autonomous wireless device charge management program 150 may retrieve and analyze a digital credential within a repository, such as storage 124 and/or remote database 130, related to one or more of a user's medical condition, employment classification and/or any area that might necessitate priority access stored on the device and/or temporarily share data with the autonomous wireless device charge management program 150. In one or more embodiments, the autonomous wireless device charge management program 150 may read the generated digital credentials in a facility's medical, emergency, and accessible devices, such as facility rental or free, loanable devices. For example, a hospital may embed digital credentials into each on-premises chargeable device and categorize the fleet of devices based on emergency need. In such as a situation, the autonomous wireless device charge management program 150 may access the stored digital credentials when assigning a priority.

Additionally, the autonomous wireless device charge management program 150 may assign a priority to each wireless chargeable device in the predefined space based on a definition of each assignment category (e.g., low, medium, high, and critical). A “low” assignment category may be appropriate for entertainment devices associated with lower availability needs (e.g., gaming devices). A “medium” assignment category may be appropriate for personal communication devices (e.g., cellphones and smartwatches). A “high” assignment category may be appropriate for assistive devices important for individuals or groups with accessibility needs (e.g., hearing aids, wheelchairs, etc.). A “critical” assignment category may be appropriate for devices critical to health and safety of an individual or area (e.g., a pacemaker or a CO₂ sensor).

In one or more further embodiments, the autonomous wireless device charge management program 150 may generate a prioritization based on each category-assigned device within the preconfigured space. The autonomous wireless device charge management program 150 may prioritize charging of devices based on assigned category, wireless charging capabilities, and current battery charge level.

The autonomous wireless device charge management program 150 may update or regenerate the prioritization under various circumstances, such as a preconfigured time period, in real time, or upon detecting a new wireless chargeable device within the preconfigured space. For example, the autonomous wireless device charge management program 150 may determine a user in possession of a wireless chargeable device has entered the preconfigured area in possession of a device assigned to the “critical” category that is low on battery power. As such, the autonomous wireless device charge management program 150 may place the low battery power, category “critical” device on top of the generated prioritization thereby updating the prioritization.

In another embodiment, the autonomous wireless device charge management program 150 may continuously monitor the battery level of each categorized device and reprioritize the devices based on updated battery life measurements. For example, if an original prioritization placed Device A at full power in the “critical” category, Device B at 75% power in the “high” category, and Device C at 90% power in the “high” category in that order, the autonomous wireless device charge management program 150 may reprioritize the order to Device B. Device A, and Device C should Device B fall below 50% battery power when Device A remains at full power and Device C remains at 90% power. A user, such as a system administrator or developer, may preconfigure the criteria used to prioritize each device both within the original prioritization and any updates or reprioritizations. In at least one other embodiment, the autonomous wireless device charge management program 150 may utilize a cognitive neural network and/or one or more machine learning techniques to generate the original prioritization or any updates or reprioritizations. Furthermore, machine learning may be utilized to train the autonomous wireless device charge management program 150 for improved accuracy during the prioritization and reprioritization processes.

In at least one embodiment, the autonomous wireless device charge management program 150 may monitor the battery level of each categorized device through receiving captured audio from one or more sensors within the predefined area for power leave alert notifications. For example, a device may play a tone or tune when the device's battery level has reached a critical state and is in need of immediate charging. In such situations, the autonomous wireless device charge management program 150 may capture the transmitted audio through an audio capture sensor, such as a microphone, and utilize this captured information to update the prioritization.

Then, at 212, the autonomous wireless device charge management program 150 generates a charging beamform pattern in the preconfigured space based on the assigned priorities. Based on the prioritization in step 210, the autonomous wireless device charge management program 150 may adjust the position and orientation of each charging beamformer in the predefined space according to the device charging priorities. Each beamformer may include one or more motorization devices to allow the autonomous wireless device charge management program 150 to instruct a direction at which each beamformer should direct a charging beam and at what distance the transmitted beam should focus to allow wireless charging of the target device based on the generated floor plan. In one or more embodiments, the autonomous wireless device charge management program 150 may update the location of each device being charged by a beamformer on a preconfigured schedule or in real time so as to ensure each device does not lose a charging connection to each beamformer despite movement around and/or within the predefined space.

Referring now to FIG. 3, an exemplary implementation block diagram of a system architecture 300 for autonomous wireless device charge management according to at least one embodiment. In one embodiment, system architecture 300 may include one or more wireless chargers 302 distributed around a predefined space 336. The predefined space 336 may include a wireless network and devices 338 connected to that network. Any number of devices may be connected to the network, such as Device-1 340, Device-2 342, . . . . Device-N 344.

The wireless charger 302 may be classified as a client computing device, such as computer 101, capable of capturing various data items from one or more embedded or communicatively coupled sensors, such as a camera. The wireless charger 302 may include each component, module, or subset of the autonomous wireless device charge management program 150. For illustrative brevity, express reference to autonomous wireless device charge management program 150 within wireless charger 302 is omitted. However, in one or more embodiments, wireless charger 302 may host autonomous wireless device charge management program 150, which itself may host an autonomous wireless device charge management manager 304 that hosts an autonomous wireless device charge management service profile 306, an autonomous wireless device charge management device profile 308, an autonomous wireless device charge management data structure 310, and an autonomous wireless device charge management device, class, and priority mapping 312; an administrative user profile 314; floor plan scanner 316; floor plan repository 318; floor plan generator 320; priority list 322; device detector 324; device data collector 326; device locator 328; autonomous wireless device charge management prioritizer 330; device class priority 332; user class priority 334; device status priority 350, and beamformer 348 as well as capability of communicating with user priority class credential issuer and verification 346. In one or more additional embodiments, the autonomous wireless device charge management manager 304 may communicate with, or receive instruction from, an administrative user granted access through administrative user profile 314.

The autonomous wireless device charge management manager 150, within wireless charger 302, may also include a floor plan scanner 316 and a floor plan repository 318. The floor plan scanner 316 may utilize one or more sensors of the wireless charger 302 to capture information about the predefined space. The floor plan repository 318 may store the captured information from the floor plan scanner 316 and/or previously generated floor plans by floor plan generator 320 such as capable by storage 124. Floor plan generator 320 may utilize the information captured by floor plan scanner 316 and stored in floor plan repository 318 to generate two-dimensional or three-dimensional digital representations of the predefined space and each detected device within the predefined space.

The autonomous wireless device charge program 150 utilize device detector 324 to detect one or more devices, such as Device-1 340, Device-2 342, . . . . Device-N 344, entering or within the predefined space or connected to a wireless network associated with the predefined space. Device data collector 326 may receive characteristic information for each device, such as device type and wireless charging capabilities. Device locator 328 may receive information related to the position of each device within the predefined space. The location information received by device locator 328 may be received and/or inferred through data captured by a sensor associated with wireless charger 302, such as a camera capturing a photograph and inferring a location in the predefined space from the photograph, or by location information shared by each device after an opt-in procedure to share such information.

The autonomous wireless device charge program 150 may utilize autonomous wireless device charge prioritizer 330 to generate a priority list 322 of each detected device within the predefined space and assign a device class priority 332, a user class priority 334, and a device status priority 350 to each device based on the information collected by device data collector 326 and device locator 328. For example, the autonomous wireless device charge program 150 may assign a specific “critical” priority to devices within a hospital surgery room but a “low” priority to a gaming device within a hospital waiting room. The user class priority 334 may utilize user priority class credential issuer and verification 346 to authenticate and/or verify the specific class of an individual. For example, if the predefined space is within a medical facility, the autonomous wireless device charge program 150 may communicate with an on-site server for the medical facility to verify that each employee, patient, and/or guest should be assigned to a specific class based on the needs of each individual.

Once the priority list is generated, the autonomous wireless device charge program 150 may instructed a beamformer 348 to orient and focus a wireless charging beam to each device within the network capable of wireless charging based on the priority list 322.

It may be appreciated that FIGS. 2 and 3 provide only an illustration of one implementation and do not imply any limitations with regard to how different embodiments may be implemented. Many modifications to the depicted environments may be made based on design and implementation requirements. For example, in one or more embodiments, the autonomous wireless device charge management program 150 may, where permissible, monitor the condition of users with identified health and special assistive needs via existing visual recognition methods and potentially receiving alerts from health monitors to ensure the wireless charging priority for users of these devices.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method, the method comprising:
detecting a plurality of devices within a predefined space;
identifying a battery charge level, a wireless charging capability, a class or type, and one or more characteristics of each detected device;
generating a floor plan of the predefined space;
assigning a priority to each detected device based on the battery charge level, the wireless charging capability, the class or type, and the one or more characteristics of each detected device; and
generating a charging beamform pattern in the predefined space based on the assigned priority and the generated floor plan.

2. The method of claim 1, further comprising:
monitoring a relative position of each device to each other device in the plurality of devices with wireless charging capabilities within the generated floor plan.

3. The method of claim 1, wherein each wireless charging device is detected through one or more of a wireless network connection, a wireless network connection attempt, image recognition, and electromagnetic emissions.

4. The method of claim 1, further comprising:
capturing user characteristic data for each user associated with each detected device based on user interactions with a graphical user interface and/or image recognition from a captured image feed.

5. The method of claim 4, further comprising:
retrieving a digital credential associated with each user based on one or more user characteristics, wherein the one or more user characteristics are selected from a group consisting of a user medical condition and a user employment classification.

6. The method of claim 1, further comprising:
updating the priority assigned to each device and the charging beamform pattern using a cognitive neural network and machine learning techniques based on one or more newly detected devices within the predefined space, one or more devices within the plurality of detected devices exiting the predefined space, and a change in the battery charge level of one or more one or more devices within the plurality of detected devices.

7. The method of claim 1, further comprising:
capturing audio data emitted within the predefined space using one or more audio capture sensors;
identifying a power level alert notification emitted by a device within the plurality of detected devices and a location of the device; and
updating the priority assigned to each device and the charging beamform pattern based on the identified power level alert notification.

8. A computer system, the computer system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
detecting a plurality of devices within a predefined space;
identifying a battery charge level, a wireless charging capability, a class or type, and one or more characteristics of each detected device;
generating a floor plan of the predefined space;
assigning a priority to each detected device based on the battery charge level, the wireless charging capability, the class or type, and the one or more characteristics of each detected device; and
generating a charging beamform pattern in the predefined space based on the assigned priority and the generated floor plan.

9. The computer system of claim 8, wherein the method further comprises:
monitoring a relative position of each device to each other device in the plurality of devices with wireless charging capabilities within the generated floor plan.

10. The computer system of claim 8, wherein each wireless charging device is detected through one or more of a wireless network connection, a wireless network connection attempt, image recognition, and electromagnetic emissions.

11. The computer system of claim 8, wherein the method further comprises:
capturing user characteristic data for each user associated with each detected device based on user interactions with a graphical user interface and/or image recognition from a captured image feed.

12. The computer system of claim 11, wherein the method further comprises:
retrieving a digital credential associated with each user based on one or more user characteristics, wherein the one or more user characteristics are selected from a group consisting of a user medical condition and a user employment classification.

13. The computer system of claim 8, wherein the method further comprises:
updating the priority assigned to each device and the charging beamform pattern using a cognitive neural network and machine learning techniques based on one or more newly detected devices within the predefined space, one or more devices within the plurality of detected devices exiting the predefined space, and a change in the battery charge level of one or more one or more devices within the plurality of detected devices.

14. The computer system of claim 8, wherein the method further comprises:
capturing audio data emitted within the predefined space using one or more audio capture sensors;
identifying a power level alert notification emitted by a device within the plurality of detected devices and a location of the device; and
updating the priority assigned to each device and the charging beamform pattern based on the identified power level alert notification.

15. A computer program product, the computer program product comprising:
one or more computer-readable tangible storage medium and program instructions stored on at least one of the one or more tangible storage medium, the program instructions executable by a processor capable of performing a method, the method comprising:
detecting a plurality of devices within a predefined space;
identifying a battery charge level, a wireless charging capability, a class or type, and one or more characteristics of each detected device;
generating a floor plan of the predefined space;
assigning a priority to each detected device based on the battery charge level, the wireless charging capability, the class or type, and the one or more characteristics of each detected device; and
generating a charging beamform pattern in the predefined space based on the assigned priority and the generated floor plan.

16. The computer program product of claim 15, wherein the method further comprises:
monitoring a relative position of each device to each other device in the plurality of devices with wireless charging capabilities within the generated floor plan.

17. The computer program product of claim 15, wherein each wireless charging device is detected through one or more of a wireless network connection, a wireless network connection attempt, image recognition, and electromagnetic emissions.

18. The computer program product of claim 15, wherein the method further comprises:
capturing user characteristic data for each user associated with each detected device based on user interactions with a graphical user interface and/or image recognition from a captured image feed.

19. The computer program product of claim 18, wherein the method further comprises:
retrieving a digital credential associated with each user based on one or more user characteristics, wherein the one or more user characteristics are selected from a group consisting of a user medical condition and a user employment classification.

20. The computer program product of claim 15, wherein the method further comprises:
updating the priority assigned to each device and the charging beamform pattern using a cognitive neural network and machine learning techniques based on one or more newly detected devices within the predefined space, one or more devices within the plurality of detected devices exiting the predefined space, and a change in the battery charge level of one or more one or more devices within the plurality of detected devices.
